(19) United States
(12) Patent Application Publication
(10) Pub. No.: US 2012/0021245 A1
(43) Pub. Date: Jan. 26, 2012

(54) PROCESS FOR JOINING CARBON STEEL PART AND ZIRCONIA CERAMIC PART AND COMPOSITE ARTICLES MADE BY SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); WEN-FENG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/097,211

(22) Filed: Apr. 29, 2011

(30) Foreign Application Priority Data
Jul. 22, 2010 (CN) 201010233868.8

(51) Int. Cl. B32B 15/04; B32B 18/00; B23K 11/16

(52) U.S. Cl. 428/629; 219/118

(57) ABSTRACT

A process for joining a carbon steel part and a zirconia ceramic part, comprising steps of: providing a metal part made of carbon steel, a ceramic part made of zirconia ceramic, and a titanium foil; bringing the metal part, ceramic part, and titanium foil into contact, with the titanium foil inserted between the metal part and ceramic part; applying a joining pressure of about 10˜50 MPa to the parts to be joined; and simultaneously applying a pulse electric current to the parts while the joining pressure is applied for heating up the parts to a joining temperature of about 800° C. to about 1100° C. at a rate of about 50˜600° C./min, maintaining the joining temperature for about 10˜50 minutes.

### CROSS-REFERENCE TO RELATED APPLICATIONS

The present application is related to co-pending U.S. patent application (Attorney Docket No. US34451), entitled “PROCESS FOR JOINING STAINLESS STEEL PART AND ALUMINA CERAMIC PART AND COMPOSITE ARTICLES MADE BY SAME”, by Zhang et al. These applications have the same assignee as the present application and have been concurrently filed herewith. The above-identified applications are incorporated herein by reference.

### BACKGROUND

1. Technical Field

The exemplary disclosure generally relates to a process for joining a metal part and a ceramic part, especially to a process for joining a carbon steel part and a zirconia ceramic part, and an article made by the process.

2. Description of Related Art

It is desirable to join carbon steel parts and zirconia ceramic parts. However, due to distinct physical and chemical properties, it is difficult to join carbon steel and zirconia ceramic using traditional bonding methods such as braze welding, fusion welding, solid diffusion bonding.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary process for joining carbon steel part and zirconia ceramic part, and composite article made by the process. Moreover, in the drawings like reference numerals designate corresponding parts throughout the several views. Wherever possible, the same reference numbers are used throughout the drawings to refer to the same or like elements of an embodiment.

FIG. 1 is a schematic cross-sectional view of an example of a spark plasma sintering device for implementing the present process.

FIG. 2 is a cross-sectional view of an exemplary embodiment of the present article made by the present process.

### DETAILED DESCRIPTION

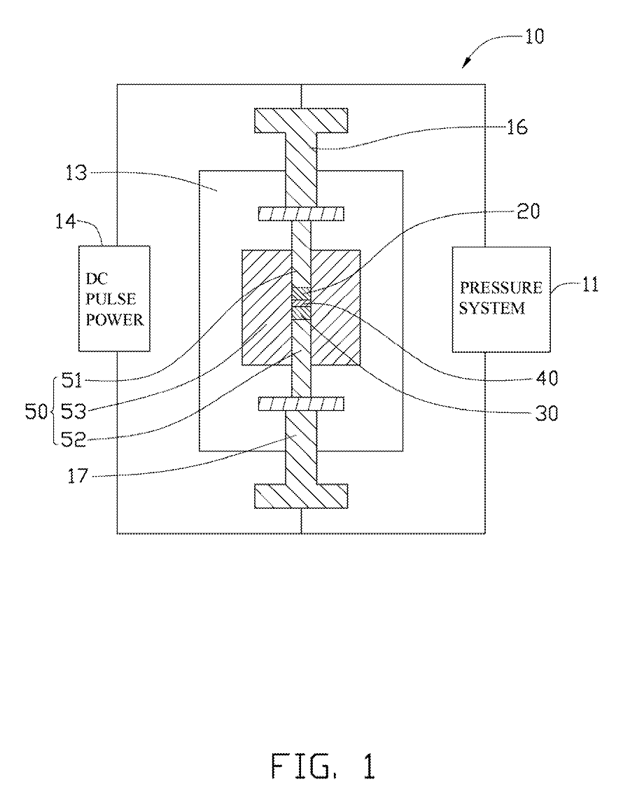

The process according to the present disclosure is generally implemented by a spark plasma sintering (SPS) device as illustrated in FIG. 1.

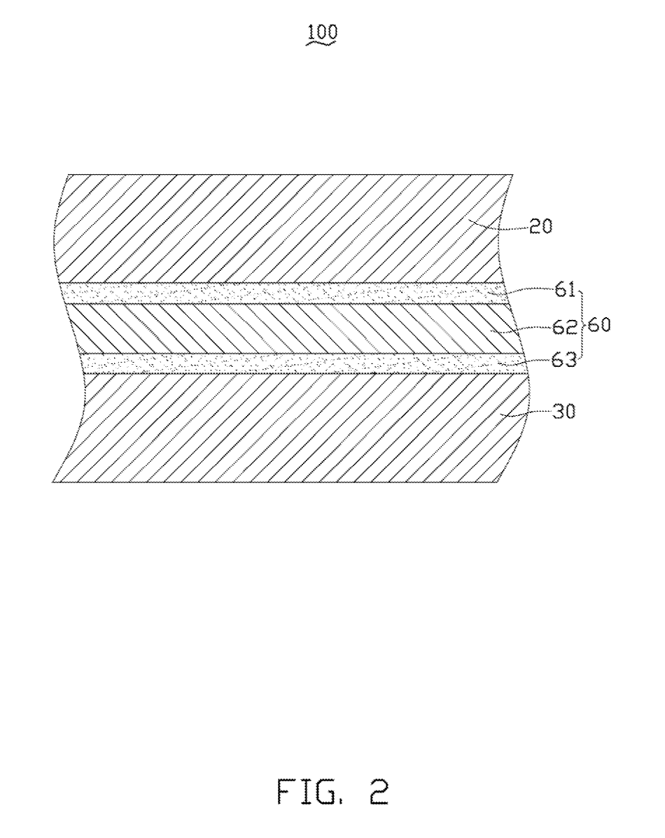

Referring to FIGS. 1 and 2, an exemplary process for joining a carbon steel part and a zirconia ceramic part may include the following steps.

A metal part 20 made of carbon steel, a ceramic part 30 made of zirconia ceramic, and an intermediate member 40 are provided. The intermediate member 40 is used as a joining medium between the joining surfaces of the metal part 20 and the ceramic part 30. The intermediate member 40 may be a titanium foil having a thickness of about 0.1˜0.5 mm. In this exemplary embodiment, the thickness of the active intermediate member 40 is about 0.2˜0.3 mm.

The metal part 20, ceramic part 30, and intermediate member 40 are pretreated. The pretreatment may include the step of polishing the surfaces of the metal part 20, ceramic part 30, and intermediate member 40, by 400˜800 grit abrasive paper. Then, the metal part 20, ceramic part 30, and intermediate member 40 may be activated by cleaning with solution containing hydrochloric acid or sulphuric acid. Then, the metal part 20, ceramic part 30, and intermediate member 40 are rinsed with water and dried.

A mold 50 made of electro-conductive material, such as graphite, is provided as shown in FIG. 1. The mold 50 includes an upper pressing head 51, a lower pressing head 52, and a middle part 53. The middle part 53 defines a cavity (not shown) for accommodating parts to be joined.

The metal part 20, ceramic part 30, and intermediate member 40 are placed into the mold 50 with the intermediate member 40 inserted between the metal part 20 and the ceramic part 30. The upper pressing head 51 and the lower pressing head 52 from two opposite sides, brings the surfaces of the parts to be joined into tight contact, for compressing the metal part 20, ceramic part 30, and intermediate member 40 therebetween.

A SPS device 10 is provided. The SPS device 10 includes a pressure system 11 for providing pressure to the parts to be joined, a sintering chamber 13, and a DC pulse power 14 for providing pulse current to the parts and heating up the parts. In this exemplary embodiment, the SPS device 10 is a “SPS3.20MK-IV” type device sold by SUMITOMO Ltd.

The mold 50 is placed in the sintering chamber 13. The upper pressing head 51 and the lower pressing head 52 are electrically connected to the positive electrode 16 and negative electrode 17 of the DC pulse power 14. The sintering chamber 13 is evacuated to a vacuum level of about 6 Pa to about 10 Pa. A pressure, known as the joining pressure of about 10˜50 MPa is then applied to the parts through the upper pressing head 51 and the lower pressing head 52. While the joining pressure is applied, a pulse electric current of about 2500˜4500 A is simultaneously applied to the parts, heating the parts at a rate of about 50˜600 degrees Celsius per minute (° C./min). When the temperature of the parts achieves the joining temperature (about 800° C. to about 1100° C.), the parts are maintained at the joining temperature for about 10˜50 minutes. Under the joining pressure and the joining temperature, particles of the metal part 20, ceramic part 30, and intermediate member 40 react and diffuse with each other to form a joining part 60 (shown in FIG. 2) between the metal part 20 and the ceramic part 30. Thereby, the metal part 20 and the ceramic part 30 are joined via the intermediate member 40, forming a composite article 100. In this exemplary embodiment, the parts are heated at a rate of about 50˜300° C./min. The joining temperature is about 850° C. to about 1050° C. The joining temperature is maintained for about 10˜30 minutes.

Once cooled down, the composite article 100 can be removed.

The present process, produces a final, permanent joint, of maximum strength. The process requires a short hold time and a low vacuum level of the sintering chamber 13, thus producing significant time and energy savings.

FIG. 2 shows a composite article 100 manufactured by the present process. The composite article 100 includes the metal part 20, the ceramic part 30, and the now-formed joining part 60. The joining part 60 includes a first transition layer 61, a titanium layer 62, and a second transition layer 63. The first transition layer 61 is located between the metal part 20 and the titanium layer 62. The first transition layer 61 may be substantially comprised of solid solutions of titanium and iron and intermetallic compounds of titanium and iron. The second transition layer 63 is located between the ceramic part 30 and the titanium layer 62. The second transition layer 63 may be substantially comprised of compounds of titanium and oxygen, compounds of titanium and zirconium, and a few of solid solution of titanium and zirconium.

The first transition layer 61 and the second transition layer 63 each may have a thickness of about 5˜30 μm, and preferably about 10˜20 μm.

The joining part 60 of the composite article 100 has no crack and aperture, and has a smooth surface. The carbon steel/zirconia ceramic interface of the composite article 100 has a shear strength of about 80˜150 MPa.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A process for joining a carbon steel part and a zirconia ceramic part, comprising steps of:
providing a metal part made of carbon steel, a ceramic part made of zirconia ceramic, and a titanium foil;
bringing surfaces of the metal part, ceramic part, and titanium foil into contact, with the titanium foil inserted between the metal part and ceramic part;
applying a joining pressure of about 10˜50 MPa to the metal part, ceramic part, and titanium foil; and simultaneously applying a pulse electric current to the metal part, ceramic part, and titanium foil while the joining pressure is applied, heating up the metal part, ceramic part, and titanium foil to a joining temperature of about 800° C. to about 1100° C. at a rate of about 50˜600° C./min, and maintaining the joining temperature for about 10˜50 minutes.

2. The process as claimed in claim 1, wherein the step of bring surfaces into contact further comprises placing the metal part, ceramic part, and titanium foil in a mold; the mold including an upper pressing head and a lower pressing head; the upper pressing head and the lower pressing head from two opposite sides for compressing the metal part, ceramic part, and titanium foil therebetween.

3. The process as claimed in claim 2, wherein the mold is made of graphite.

4. The process as claimed in claim 2, wherein the step of applying the joining pressure further comprises placing the mold in a sintering chamber of a spark plasma sintering device spark plasma sintering, the joining pressure being applied to the metal part, ceramic part, and titanium foil through the upper pressing head and the lower pressing head.

5. The process as claimed in claim 4, wherein the sintering chamber being evacuated to a vacuum level of about 6 Pa to about 10 Pa.

6. The process as claimed in claim 4, wherein the spark plasma sintering device has a DC pulse power, the upper pressing head and the lower pressing head are respectively electrically connected with the positive electrode and the negative electrode of the DC pulse power.

7. The process as claimed in claim 1, wherein the metal part, ceramic part, and titanium foil are heated at a rate of about 50˜300° C./min.

8. The process as claimed in claim 1, wherein the joining temperature is about 850° C. to about 1050° C., the joining temperature maintained for about 10˜30 minutes.

9. The process as claimed in claim 1, wherein the pulse electric current applied to the metal part, ceramic part, and titanium foil is about 2500˜4500 A.

10. The process as claimed in claim 1, wherein the titanium foil has a thickness of about 0.1˜0.5 mm.

11. The process as claimed in claim 1, wherein the process further comprising polishing the metal part, ceramic part, and titanium foil and activating the metal part, ceramic part, and titanium foil by cleaning with solution containing hydrochloric acid or sulphuric acid, before the step of bring into contact.

12. A composite article, comprising:
a metal part made of carbon steel;
a ceramic part made of zirconia ceramic; and
a joining part, the joining part including a first transition layer, a titanium layer, and a second transition layer, the first transition layer being located between the metal part and the titanium layer, the first transition layer being comprised of solid solutions of titanium and iron and intermetallic compounds of titanium and iron, the second transition layer being located between the ceramic part and the titanium layer, the second transition layer being comprised of compounds of titanium and oxygen, compounds of titanium and zirconium, and solid solution of titanium and zirconium.

13. The composite article as claimed in claim 12, wherein the first transition layer and the second transition layer each has a thickness of about 5˜30 μm.

14. The composite article as claimed in claim 13, wherein the first transition layer and the second transition layer each has a thickness of about 10˜20 μm.

15. The composite article as claimed in claim 12, wherein the composite article has a shear strength of about 80˜150 MPa.
